(19) United States
(12) Patent Application Publication
(10) Pub. No.: US 2007/0070233 A1
(43) Pub. Date: Mar. 29, 2007

(54) System and method for correlating captured images with their site locations on maps

(76) Inventor: Raul Dario Patterson, Miami, FL (US)

Correspondence Address: MALLOY & MALLOY, P.A., 2800 S.W. Third Avenue, Historic Coral Way, Miami, FL, 33129, US

(21) Appl. No.: 11/237,052

(22) Filed: Sep. 28, 2005

(51) Int. Cl. H04N 5/222

(52) U.S. Cl. 348/333.12

(57) ABSTRACT

A system and method for spatial representation of image capture zones associated with captured images, their site locations and imaging assemblies, which capture the intended image, on a corresponding map of the site location of an imaging assembly and the subjects of the captured images display. The imaging assembly includes location, orientation position and orientation determining capabilities, wherein metadata associated with the location, and orientation of the imaging assembly during capturing of the image is associated with the original photographic image data to create the capture zones on a map display. The map display includes a population of one or more capture zones each indicative of a position and orientation of the imaging assembly when an image was captured and field of view of the imaging assembly. When the capture zones are accessed, a representation of the captured photographic image data is displayed.

### BACKGROUND OF THE INVENTION

1. Field of the Invention

This invention relates to a system and method of correlating captured images with site locations associated with the position of both the subject matter of the captured image and an imaging assembly used to photograph the subject matter. The imaging assembly is operatively associated with position, orientation and angle of view determining capabilities such that the field of view, angle of orientation and other data can be represented on a map application populated with symbols indicative of capture zones of the image data.

2. Description of the Related Art

With the fairly recent advancement in modern technology relating to digital photography, including the capturing of both still and moving images, the captured image data can be appropriately processed for versatile and interactive display. Further, the existence of positioning systems such as the popular Global Positioning System (GPS) enables extremely accurate determination of the location of various objects, vehicles, etc. A typical application for such modern day capabilities includes the selective display of flight images of scenes obtained by recognizance cooperatively transmitted and processed using appropriate computerized technology that works with map data of a predetermined spatial reference system. Some applications of the types set forth above are useful for mission planning, guidance, downrange tracking in both real life and computer simulated situations. In addition, reference maps may be prepared for various locations from imagery previously obtained by airborne or satellite platforms, wherein the imagery may be processed to meet certain predetermined requirements.

In addition, the organization or categorization of digital photography, in the form of independently captured images, may be geographically arranged by associating captured images with locations where the image capturing has occurred. As such, a more versatile and informative viewing of the captured images is available either in the form of still photographs or video displays.

However, one drawback of previously proposed geographic organizational displays of digital image data is the generally recognized difficulty of accurately determining the “capture zone” of image data as it relates to other elements present in a map display. The capture zone is the spatial extent of the subject matter of the image data. All whole objects or parts thereof seen in the image data are in the capture zone. Capture zones have definable extents that can be shown on a map. It is user of the map which images may contain an area or object(s) of interest. Difficulties arise, at least in part, because operative image systems and methods are not readily available and accordingly not widely used.

In order to overcome problems and disadvantages of the types set forth above, proposals have been contemplated which enable or allow a user to subsequently establish a position and direction of a captured image site into an electronic or digital photograph display. The basic concept of subsequently correlating location data with previously established image data is considered to be at least minimally possible. However, the practical application is limiting to the extent that although certain physical parameters of the camera may be shown on the map display, such as position and orientation, an accurately defined capture zone is not. As such, the objects and the surroundings that have been photographed cannot be accurately determined on a map.

Accordingly, the above set forth problems and disadvantages could be readily overcome through the development of a proposed method and system for concurrently and instantly correlating captured image data with “capture zones”. Further, a preferred and proposed system and method will include the processing of mapping data, preferably in the form of a predetermined and appropriate map software application with image data such that the mapping data and the image data are correlated to establish an interactive, accessible display that defines and identifies capture zones. Also, in an improved and proposed system, the established display would be readily viewable on any type of appropriate display assembly and be interactive with a viewer. Moreover, in a preferred system a photograph or video, as a portion of the captured image data, should be capable of being viewed in combination with its capture zone(s). Such a preferred system and method would thereby provide the viewer with informative details relating to field of view of the imaging assembly when the image is captured as well as precise angle of orientation of the central line of sight, often referred to as the optical axis of the imaging assembly, relative to horizontal or any other reference parameter.

Therefore, a proposed system and method to overcome known and recognized disadvantages and problems in related art technology should incorporate a combination of hardware and software applications including digitally operative photographic imaging assemblies which may be peripherally or integrally associated with location, orientation and angle of view determining facilities. As a result, a preferred system and method could provide for captured image data to be associated or integrated with metadata, the latter being representative of the location, orientation, and angle of view of the digital camera or like imaging assembly when the image data is captured. The resulting integrated image data could then be effectively correlated into appropriate digital mapping data resulting in a map application display populated with accessible and informative indicators of image capture zones.

### SUMMARY OF THE INVENTION

The present invention is directed to a system and method for the spatial representation of images and their image capture zones operatively associated with a predetermined map. More specifically, the system and method of the present invention is applicable for correlating images of predetermined subject matter with the spatial representation and delineation of their respective capture zones on geographical maps and digital map applications. Moreover, captured image data can be selectively displayed as a photograph or video image of the subject matter being photographed along with the surrounding environment when desired. In addition, the orientation of the imaging assembly is made readily apparent to the viewer by indicating the angle of orientation of the central line of sight, relative to horizontal and/or other reference parameters, as the imaging assembly is oriented relative to the subject matter or portion thereof being photographed. As used herein the “central line of sight” is collinear with the optical axis of the imaging assembly and these two terms may be used synonymously.

Accordingly, the system of the present invention utilizes the aforementioned imaging assembly which is preferably in the form of a film or digital photographic or video camera capable of creating still photographs and/or video imaging data that includes angle of view. As such, the imaging assembly includes location, orientation, as well as angle of view determining capabilities.

In the one or more preferred embodiments described herein, the position determining capabilities of the digital camera comprises a geographic positioning system such as the well known Global Positioning System (GPS). Having such capabilities, the imaging assembly can be disposed at any appropriate location relative to the subject matter of the captured image data. Operation of the GPS, or other position determining facility, will enhance the precise determination of the position of the imaging assembly when it is properly positioned to capture the image of the predetermined subject matter.

In addition, the imaging assembly of the present invention also includes orientation determining capabilities which may be integrated therein or otherwise peripherally associated therewith. The orientation capabilities are operative to allow the determination of the angle(s) of the central line of sight of the digital imaging assembly relative to the axes of predetermined parameters of the spatial reference system, as the imaging assembly captures the selected image data from the subject matter being photographed. The spatial reference system may comprise, for example, a map projection with an established coordinate system and horizontal (and optionally vertical) datum. In addition to angle(s) of orientation, the imaging assembly also has the capability to record and store the angle of view associated with each image captured.

The data or information relating to the position of the imaging assembly as well as its orientation, and angle of view, as set forth above, is defined in terms of metadata which is then integrated into or associated with, the initially defined image data of the subject matter being captured. The image data, together with the metadata relating to the position, orientation, and angle of view of the imaging assembly is then stored on appropriate digital data storage media, which is operatively associated with the imaging assembly. The storage media may take the form of either customized or substantially conventional devices such as a flashcard removably and operatively connected to the digital camera. The metadata may be stored on the same medium as the captured image data, or it may be stored on a separate medium and later associated with its corresponding image data.

Once the image data and metadata, as previously defined, are captured and stored they may be correlated with conventional or customized mapping data comprising one or more software applications of maps. The selected map application will correspond with a geographical site associated with the position or physical or geographical location of the imaging assembly and the subjects of the image data and their environment. In addition, one or more capture zones are displayed when viewing the map application, such as by means of a conventional viewing assembly, as will be explained in greater detail hereinafter. As also described the geometry of the capture zone will be at least partially defined in terms of the same spatial reference system as the map data.

More specifically, capture zones are at least partially defined by the optical/physical properties of the camera lens of the imaging assembly and the position and orientation of the imaging assembly. As demonstrated in greater detail hereinafter, one preferred embodiment of the present invention comprises the capture zones having an operative shape of a regular pyramid with a rectangular base, wherein the apex thereof is located at or adjacent the lens assembly of the imaging assembly as determined by the positioning assembly (GPS). Furthermore, the axis of symmetry of the pyramid is collinear with the central line of sight of the imaging assembly and perpendicular to the plane of the base. Moreover, the aforementioned base is proportional to the active area of the camera's photosensitive sensor. However, as viewed when appearing on a map application using an appropriate viewing assembly, the capture zones appear as two dimensional areas on a “flat” map.

One or more of the preferred embodiments would show at least one, but more practically a plurality of capture zones appearing on a map display (either in two or three dimensions) by using the geometric relationships defining capture zones described herein. The map display may contain other map data and/or imagery of the environment that may contain some of the objects that appear in the digital photographic image, partially or entirely within the capture zone(s). As practically applied, an appropriate computer, processor facility or the like hardware, will process the aforementioned storage medium and the image data including metadata associated therewith to the extent of correlating an appropriate map application with the integrated image data and capture zones to establish or define accessible display data. Preferably the hardware would have operative capabilities which would allow a user to interact with the map display. By way of example, a user could apply a pointer on a capture zone or site location and thereby cause the corresponding image to be displayed.

As used herein, the accessible display data comprises, but is not limited to a schematic, digital display of the map application corresponding to the environment, and/or geographical location of the site location of the imaging assembly and the subject matter of the image data specifically including the one or more capture zones.

The display assembly may be directly associated with the aforementioned processor/hardware or may be peripherally connected to or otherwise associated therewith. In any case, the accessible display data would either be downloaded directly into the processor or made available by virtue of a variety of other storage media such as optical storage disk i.e. DVD, etc. Once viewed, the accessible display data will include the aforementioned appropriate map application populated with at least one but perhaps more practically a plurality of shapes and/or markings representing capture zones and/or a plurality of oriented symbols representing camera positions/orientations, respectively. The one or more capture zone figures and/or indicia symbols would be accurately disposed on the map application and be linked to the integrated image data comprised of the photographic or video imaging.

In addition, at least one but more practically all or a majority of the symbols displayed on the map application would also include one or more position/orientation indicators. The position/orientation indicators would be schematically representative of the central line of sight of the imaging assembly when the image of the subject matter was captured. In order to provide a completely informative representation of the captured image data, the map application would also include one or more capture zones. Each of the capture zones would be indicative, in substantially precise terms, of the spatial extent of the field of view of the imaging assembly for each image data captured.

By way of example, the location of a digital camera properly positioned and oriented to capture the image of a relatively tall building may be utilized to take a series of photographs of an exterior of the building at different angular orientations. As such, a first photograph may be taken of a ground level location of the building. A second photograph may be taken, wherein the imaging assembly is oriented upwardly at a predetermined angle of orientation so as to capture the image of the first five floors of the building. A successive photograph may then be taken to capture the image of higher portions of the building, wherein the angular orientation of the imaging assembly, relative to horizontal, would be greater than the first or second previously assumed orientations. Accordingly, when the aforementioned accessible display data was established, a map application of the location of the imaging assembly relative to the building could be viewed with a specified symbol appearing on the map application. The symbol would represent the location of the digital imaging assembly relative to the building at the site location of both the imaging assembly and the subject matter being photographed. Capture zones would be associated with each symbol and may be in the form of preferably two radial lines extending outwardly there from and separated by an orientation angle at least partially indicative of the field of view of the imaging assembly relative to the central line of sight of the imaging assembly. As such, the capture zone indicators would be representative of the field of view of the digital assembly as the image of the subject matter was captured. Further, a viewer could interact with the symbol by accessing it by means of a pointer or the like. Accessing the symbol would result in a visual display of successive images (photographs) through which a user may scroll. Display of the first photograph at ground level would indicate a zero angle of orientation in that the central line of sight of the imaging assembly would be substantially located parallel to horizontal. The second photograph would have a greater angle of orientation indicated by an appropriate symbol and the successive photographs would have increasingly greater angles of orientation, each representative of the corresponding central line of sight at which the imaging assembly was oriented in order to capture respective images. GPS may be used for determining position, and other devices such as an inclinometer may be used to determine orientation, which may be represented as a vertical angle from horizontal, as demonstrated in more detail hereinafter.

Demonstration of the proficiency and extended versatility of the system and method of the present invention can best be accomplished by reference to yet another example which is not to be interpreted in a limiting sense. This additional example comprises the use of a digital camera or like imaging assembly capturing images of various objects within a theme or amusement park. Naturally, the subject matter of the captured images which at least partially defines the various image data referred to herein, may comprise one or more individuals, buildings, animated characters, displays, or any of an almost infinite variety of individual or combined objects. As set forth above, the imagining assembly of the present invention would have the aforementioned capabilities to record the position, orientation, and angle of view. This metadata would be associated with or integrated into each image. The image data and metadata would then be stored on an appropriate storage medium either physically integrated with the imaging assembly, such as a flashcard, built-in memory or the like, which would be operative with and removably connected to the digital camera, or, transmitted to a physically separate system via a hardwire or wireless network.

Once the capturing of the intended digital images is completed, the image data and metadata would be processed by a kiosk, which may be located within the theme park, or other appropriate facilities which includes processing capabilities. As such, the processor would be structured to establish the accessible display data which comprises or at least is generally defined as the correlated mapping data and image data with associated metadata. Such accessible display data could then be downloaded or stored onto yet another appropriate storage medium such as DVD or the like. Delivery of the DVD would be presented to the initial user of the digital camera for later display using an appropriate display assembly such as of the type associated with a conventional personal computer, laptop, DVD player, etc.

Interactive accessing of the DVD containing the display data would result in a visual display of appropriate map software or applications representative of the theme or entertainment park. Populated thereon would be a plurality of symbols each representative of the location of the imaging assembly during capture of the various images. Accessing the symbols by a pointer or the like would result in a visual display of the photograph or video of the subject matter along with the surrounding environment where appropriate. Also the one or more displayed capture zones associated with each of the one or more captured images would thereby provide an accurate representation on the displayed map application of the subject matter of the captured images.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1A is a schematic representation of one preferred embodiment of the system and method of the present invention.

FIG. 1B is a detailed, cutaway view of a portion of the embodiment of FIG. 1A.

FIGS. 2A and 2B are schematic representations illustrating operative and structural features of the various preferred embodiments of the system and method of the present invention.

FIGS. 3A, 3B and 3C are sequential, schematic views of the structural and operative features of the preferred embodiment as applied to a vertical sequence of images of an object too tall to fit in one capture zone.

FIGS. 4A and 4B are associated schematic views of representing structural and operative views of three dimensional capabilities of at least one preferred embodiment of the system and method of the present invention.

FIG. 5 is a schematic representation of hardware associated with one or more of the preferred embodiments of the system and method of the present invention.

FIG. 6 is a schematic representation in block diagram form indicating the operative features of the system and method of the present invention.

Like reference numerals refer to like parts throughout the several views of the drawings.

### DETAILED DESCRIPTION OF THE PREFERRED EMBODIMENT

The present invention is directed to a system and method for correlating captured images with various site locations associated with the position of the subject matter of the captured images, as well as a digital imaging assembly by which the images are captured. As should be apparent, the imaging assembly may be structured to capture still images or video. With reference to the accompanying Figures, the structural and operative features including hardware and software applications associated with the various preferred embodiments of the subject invention are schematically represented.

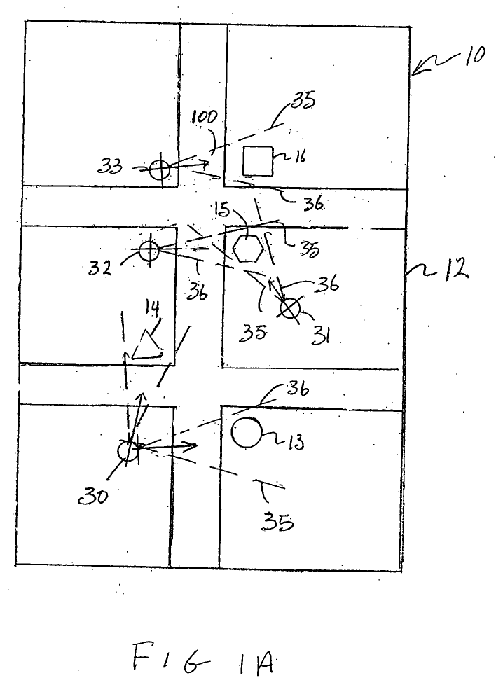

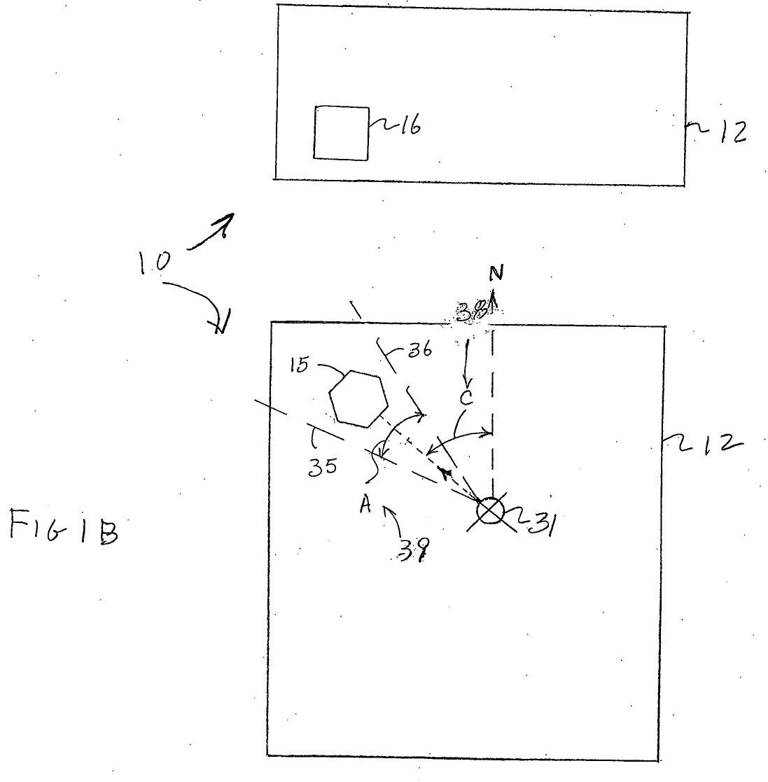

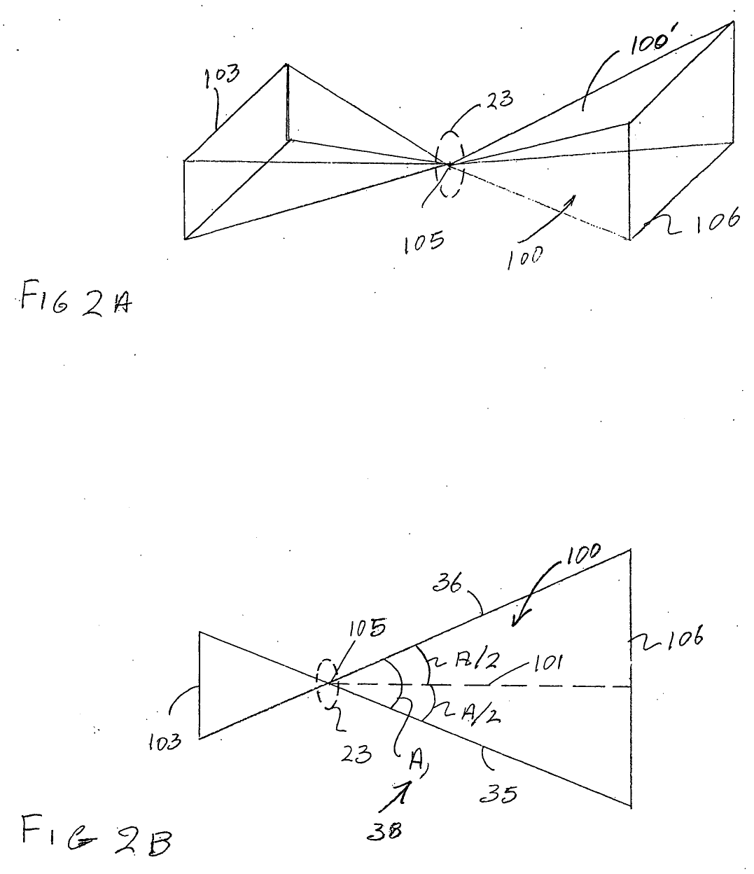

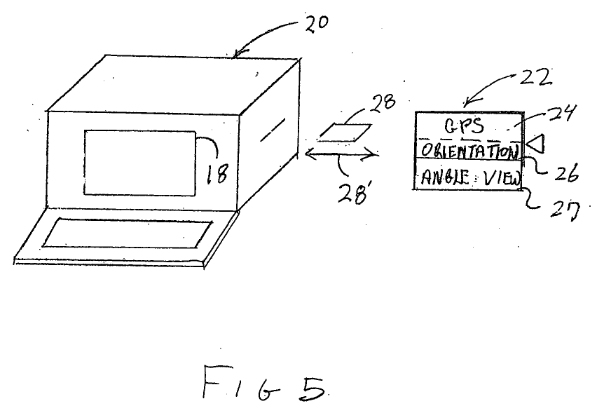

Accordingly, FIGS. 1A and 1B are representative of mapping data generally indicated as 10 and more specifically represented in the form of a predetermined map application 12 on which at least one, but more practically, a plurality of different objects 13, 14, 15, 16, etc. are represented in their appropriate geographical location. More specifically, the map application 12 is a software application representative of an accessible display which may be visually observable on a variety of different display assemblies 18. The display assembly 18 may be integrated or peripherally associated with a processor assembly 20 or be completely independent thereof, such as in the form of a DVD player, etc. Further with regard to FIGS. 1A and 1B, the various objects 13 thru 16 are intended to generally represent the subject matter of the images captured by an appropriate imaging assembly generally indicated as 22. The imaging assembly 22 is preferably a digital camera structured to take still photographs and/or video images. In addition and as primarily represented in FIG. 5, the imaging assembly 22 is structured to include a positioning system such as, but not limited to, a Global Positioning System (GPS) schematically represented as 24. Also, the imaging assembly 22 is structured to incorporate or otherwise be operatively associated with an orientation determining facility 26, wherein the orientation of the camera while capturing the digital image of any one or more of the objects 13 thru 16, etc, can be determined. Also, in at least one preferred embodiment the imaging assembly 22 has integrated or peripherally associated capabilities of determining an orientation angle “A” as schematically represented in FIGS. 1B and 2B an indicated as 39.

Other hardware associated with a preferred embodiment of the system and method of the present invention includes a storage medium 28 capable of being operatively associated with the digital imaging assembly 22 and removed there from for processing by any one of a variety of different processors 20. Directional arrow 28′ of FIG. 5 is intended to schematically represent the operative association of the appropriate storage medium 28 with the imaging assembly or digital camera 22 and the processor 20. Direction arrow 28′ may also represent the wired or wireless transmission of the image data and/or metadata between the imaging assembly and the processor or some intermediate digital storage medium. Such storage medium may comprise, but is not limited to, customized or conventional flashcards or the like. The processor 20 is capable of processing the storage medium 28 at least to the extent of correlating the mapping data 10 with the image data captured by the digital imaging assembly 22.

As an alternative preferred embodiment, the imaging assembly 22 may be structured to perform the processing procedure through the provision of a built in or otherwise associated microprocessor capable of performing the processing step relative to the captured image data. As with the processor 20 the integrated or otherwise operatively associated microprocessor will be capable of correlating the image data with the mapping data to establish an accessible display.

Accordingly, regardless of the preferred embodiment implemented, the result will be the establishment of accessible display data at least partially comprising the map application 12 with the integrated image data symbolically represented thereon. The display data can be readily displayed on any of a variety of different types of display assemblies 18, as generally set forth above.

As will be explained in greater detail hereinafter, image data captured through operation of the imaging assembly 22, such as when taking a photograph or video image of any one or more of the objects 13 through 16, will be stored on the storage medium 28 along with “metadata” comprising the position, orientation, and angle of view 38 of the image assembly 22 when images of any one or more of the objects 13 thru 16 is captured in the form of image data. For purposes of clarity, the metadata relating to the position and orientation 24 and 26 of the imaging assembly 22 will be described as being “integrated” into the image data representative of the actual photograph or video of the objects 13 thru 16 which have been captured. However, the integration or association may occur in any device capable of processing data, including some imaging assemblies, or other devices equipped with adequate processor facilities. The integrated image data stored on the storage medium 28 is then transferred to a processor 20 in order to accomplish and establish a correlation of the mapping data 10, in the form of the map application 12 and the integrated image data. Further by way of clarification, the mapping data 10 may be in the form of conventional or customized mapping software, wherein a specific and/or predetermined map application 12 is selected which is representative of a physical area containing the capture zones and any amount of surrounding space, and possibly the location and capture zone of the imaging assembly 22 when the images, in the form of photographs or video, of any one or more of the objects 13 thru 16, etc. is captured.

As set forth above, a processor 20 which may have a variety of different structures and operative features will establish accessible display data, schematically represented in FIGS. 1A and 1B, comprising a correlation of the mapping data 10 and the integrated image data. This correlation will be presented in the form of a map application 12 indicating the overall site locations of the plurality of objects 13 thru 16 being photographed, as well as the location, angle of view 38 and angle of orientation 39 of the central line of sight of the imaging assembly or digital camera 22 as the photograph or video defining the image data is captured.

Again with primary reference to FIGS. 1A and 1B, the established correlation accomplished by a processor 20 will serve to link the integrated image data with the mapping data 10 in the form of a “populated” map application 12 of an appropriate site location. Further, the established correlation of the mapping data and integrated image data will be displayed on the map application 12 by at least one but more practically a plurality of symbols 30, 31, 32, 33, etc. Each of these symbols is associated with at least one imaging assembly 22 and a capture zone corresponding to the respective imaging assemblies 22. Moreover, each of the corresponding capture zones associated with the symbols 30 thru 33 will comprise and or be indicative of the position, orientation, and field of view of the imaging assembly 22 when the image data is captured. As such, each of the symbols 30, 31, 32, 33, etc, may also define and be referred to herein as a position/orientation indicator. The relative positions and orientations of the imaging assembly 22, as represented by the symbols 30 thru 33, is established due to the fact that the imaging assembly 22 is structured to have the aforementioned location or position, orientation, and angle of view determining capabilities 24, 26, and 27 such as, but not limited to, GPS, compasses, and focal length registering device.

As also demonstrated in FIGS. 1A and 1B, the predetermined map application 12 is populated with the various symbols 30 thru 33 associated with at least one position/orientation indicator. The position/orientation indicators preferably are represented by a composite symbol preferably, but not exclusively, made up of a small symbol such as but not limited to a circle with or without cross hairs, and a superimposed arrow symbol or other pointing symbol, represented in 30 through 33. To show the capture zone at least one but more practically a pair of radial lines 35 and 36 are used extending outwardly from the individual position/orientation symbols 30 through 33 of the camera 22 as also represented in detail in FIG. 1B. As such, the use of a pair of radial lines 35 and 36 serves to appropriately indicate boundaries of the capture zone of the imaging assembly 22 when located at the corresponding symbol as at 31. Moreover, this representation of the field of view of the imaging assembly 22 on a map is more accurately and specifically described as the “capture zone” of the image data of the subject or object 15 and the corresponding or surrounding environment, etc. More specifically, the one or more capture zones, generally indicated as 100 are at least partially defined by the physical properties and dimensions of the lens 23 and the imaging sensor of the imaging assembly. As demonstrated in FIGS. 2A and 2B, one preferred embodiment of the present invention comprises the capture zones 100 having an operative shape of a pyramid with a rectangular base 103, wherein the apex 105 thereof is located at or adjacent the lens 23 of the imaging assembly 22. Furthermore, the axis of symmetry of the pyramid is collinear with the optical axis of the lens 23 (and therefore also collinear with the central line of sight 101 of the imaging assembly 22) and it is aligned with the orientation determining device. Moreover the base 103 is proportional to the active area of the camera's photographic sensor, which may be directly associated with the imaging assembly 22 and is not specifically shown for purposes of clarity. It must be noted however, as demonstrated in FIGS. 1A, 1B and 2B, that when the capture zones are viewed on a two dimensional map application, using an appropriate viewing assembly 18, the capture zones 100 comprise and/or appear as two dimensional areas (their downward vertical projection onto a “flat” map). Hereafter the flat map representation of the capture zone may also be referred to as the two-dimensional capture zone. The two dimensional representations of FIGS. 2A and 2B are as would appear on a “flat” map.

In practice, as shown in FIG. 2B, two dimensional capture zones 100 on the displayed map application 12 at least comprises the placement of the capture zone's regular pyramid apex 105 (or that of its two dimensional equivalent) at the position of the lens 23 of the imaging assembly 22 and the establishing of the two radial, bounding lines of sight 35 and 36 on the two dimensional or flat map at equal angular distances (A/2) from the central line of sight 101. As such, each bounding line of sight is located at an angular distance of ½ the angle of orientation (A) from the central line of sight 101. The length of the bounding lines of sight 35 and 36 may be set by any of a myriad of ways including, but not limited to, measured, calculated, estimated, or manually set by using focal distance, subject distance to subject, or depth of field. In one or more of the preferred embodiments, the capture zones 100 may be left open or may be enclosed, as at 106, wholly or partly by a circular arc, or lines, curves, or any combination thereof. Also, two dimensional applications may use the downward vertical projection of a three dimensional capture zones, which are described below.

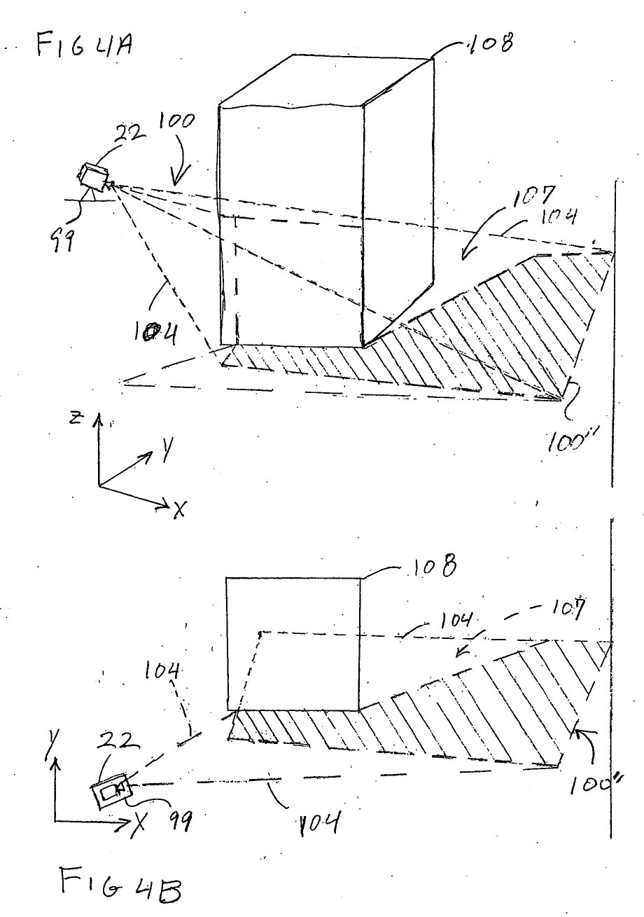

In the case of three dimensional applications, the capture zone 100′, as demonstrated in FIGS. 4A and 4B, may also be affected by the spatial relationship between the camera position/orientation 99 and the physical environment (including terrain and/or structures). This is because in a three dimensional application the capture zone 100 may be created by intersecting the capture zone's regular pyramid with a three dimensional representation of the physical environment including terrain and/or structures and other large objects that may interfere with or truncate the lines of sight in potentially irregular and/or non-symmetric ways.

With specific reference to the three dimensional schematic representation of FIGS. 4A and 4B 99 represents a position/orientation of the camera or imaging assembly disposed some distance above ground surface and oriented towards a subject. When so disposed, the camera position accesses an unobstructed capture zone 100″ which may also include a building or like object which may or may not represent the object being photographed, as at 108. However, an obstructed portion or area of the potential capture zone is schematically represented at 107 due to the size, position, etc, of the object 108 as well as the natural terrain/topography of the surroundings of the object 108. Moreover, the obstructed portion of the capture zone 107 is the result of the boundaries of the projection lines of the capture zone extending down to the ground or other supporting surface.

The above are some examples of the many possible ways to define capture zones in three dimensions. However, capture zones can have many different configurations or geometries. Also, two dimensional applications may use the downward vertical projection or plan view of a three dimensional capture zone. In summary, the preferred geometry of the capture zone 100 as defined herein will make use of a regular pyramid possibly modified by the shape and size of objects and/or terrain in the environmental display of it on a map application 12 that may contain other data.

In practice, and pertaining to the above discussion, position and orientation may be specified in terms of a spatial reference system, for example a 3-D Cartesian coordinate system based on or referenced to a state plane coordinate system. The spatial reference system may have certain predetermined horizontal and vertical datum. The position may be specified by a set of horizontal coordinates X, Y, and a vertical coordinate Z; whereas orientation may be defined by horizontal direction from a reference direction such as true north (in geographic map applications) and vertical direction upward or downward from the horizontal plane.

Another distinguishing and informative feature preferably associated with at least one, but more practically each of the symbols 30 thru 33 is one or more position/orientation symbols or indicators. The symbols could be represented by a compound symbol made up of a point, circle or other small graphic placed at the location of the imaging assembly 22 combined with an arrow or other pointing symbol oriented on the map display to show the orientation of the imaging assembly 22 when a given image data was captured. With primary reference to FIG. 1B the position/orientation indicators 31 are representative of the various possible positions/orientations of the imaging assembly 20 as well as other parameters associated with the capture zone. More specifically the orientation angle of the imaging assembly 22, relative to horizontal, or other predetermined reference parameter, when the subject matter 15 is photographed includes, but is not necessarily limited to, an angle of inclination “B”. This will provide viewers of the correlated mapping data 10 with a more accurate representation of the portion or segment of the object 15 being photographed.

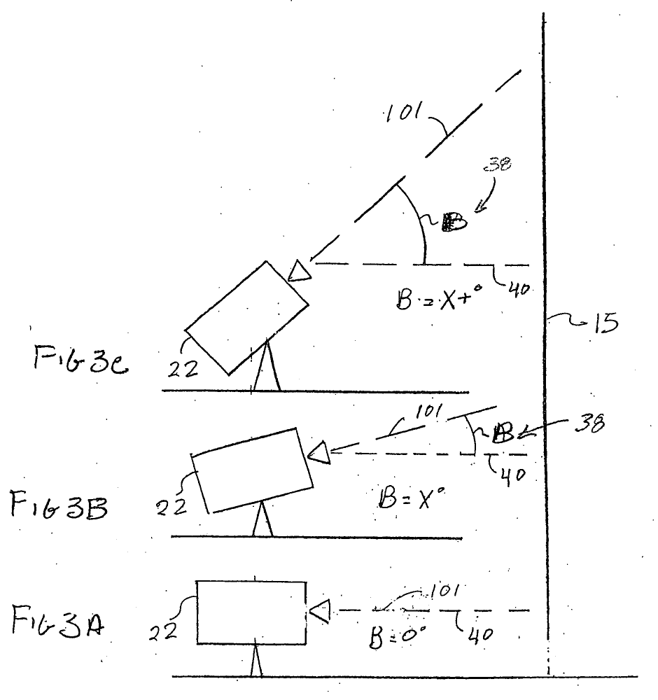

To further illustrate the angle of orientation, a purely vertical case will be presented in which a tall subject is captured in segments by varying only the angle of orientation (angle of inclination in this case). As represented in FIG. 3A, the angle of inclination of the central line of sight 101 is substantially coincident with the horizontal as schematically represented by phantom line 40. Therefore, the viewer would be made aware that when the angle “B” is zero degrees, a “straight-on” view has been taken. As represented in FIG. 3B, the angle of inclination “B” has increased from zero degrees, being coincident with the horizontal 40, to the angle of inclination being equal to X, wherein X>0. The viewer will then be made aware that the angle of inclination B of the imaging assembly 22 was at a predetermined angle of inclination of X to capture a predetermined portion or segment of the object 15. As represented in FIG. 3C the angle of inclination “B” is equal to the predetermined angle X+, which is greater than the angle of inclination X as represented in FIG. 3B. Again, the viewer will then be accurately informed of the segment or portion of the object 15 being photographed and subsequently viewed on an appropriate display assembly 18.

By way of example only, the subject or object 15 being photographed could be a tall building. As such, FIG. 3A represents a “straight on” view of a ground floor of the building 15. FIG. 3B represents a higher portion or location on the building 15 and FIG. 3c represents a photograph of an even higher floor or group of floors or exterior portion of the building 15 as schematically indicated.

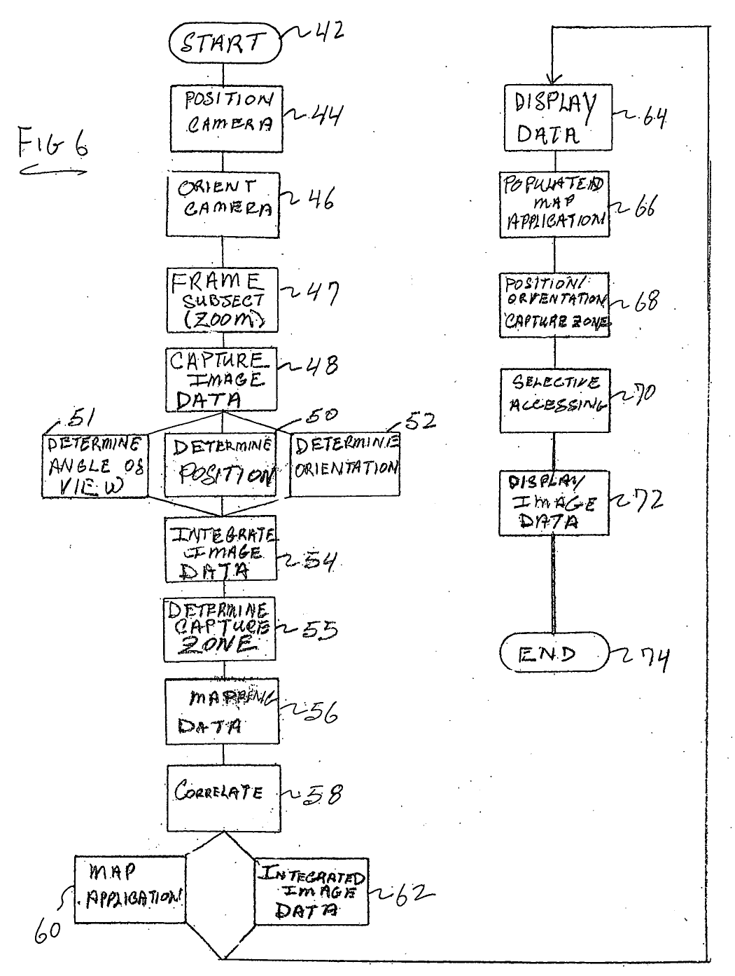

With primary reference to FIG. 6, both the structural and operational features of a preferred embodiment of the system and method of the present invention are schematically represented in block diagram form. Accordingly, in use the user or operator of the digital assembly 22 starts implementation of the system and method of the present invention as at 42. Moreover, the imaging assembly or digital camera 22 is properly positioned as at 44 so as to photograph or capture video, herein defined as image data of any of the one or more objects 13 thru 16 intended to be photographed.

When properly positioned at a given site, the imaging assembly 22 is properly oriented, as at 46, to aim the imaging assembly at the object 15 (or portion thereof) in FIGS. 3A through 3C, being imaged. The orientation, as set forth above, is represented by the angle of orientation (which in this case is defined at least in part, by the angle of inclination “B”) indicative of the direction of the central line of sight of the imaging assembly 22 relative to an arbitrary direction such as horizontal 40 as various segments or portions of the object 15 being photographed (see FIGS. 3A thru 3C).

The angle of view “C” schematically indicated as 38 represents a horizontal angle relative to an arbitrary or standard reference direction such as north (N), as various objects 13 thru 16 in an area are imaged (see FIG. 1B). In cooperation therewith, the user frames the desired subject by adjusting the magnification (i.e. zooming in or out) which may at least partially determine the angle of orientation 39 as at “A” graphically representative of the angle between the bounding lines of sight 35 and 36. Once properly positioned, oriented and magnified to capture the desired subject, the image data is captured, as at 48, which is located within the corresponding capture zone 100. For purposes of clarity and as represented in FIGS. 1B, 2B and 3A-3C, the map application 12 may include one or more angle designators 38, 39, etc, associated with one or more of the capture zones and being representative of appropriate ones of the angle of orientation “A”, angle of inclination “B” and/or angle of view “C”.

As also set forth above, the imaging assembly 22 is structured to include capabilities for determining the location, through a positioning system 24, orientation, through orientation determining capabilities 26, as well as capabilities 27 to determine the angle of view 38 associated with the imaging assembly as indicated in FIG. 6. Therefore, the included or peripherally associated position, orientation and angle of view determining capabilities 24, 26 and 27 of the imaging assembly 22 are determined as at 50, 51 and 52. As further described with reference to FIG. 5, the image data representative of the photograph or video taken of the object 15 is stored on the storage medium 28 while operatively associated with the imaging assembly 22. Thereafter and subsequent to the determination of the position, orientation and angle of view 50, 52 and 51 of the imaging assembly 22, which constitute the “metadata”, both the captured image data 48 and the metadata are integrated with one another as at 54. Capture zones are then created using the metadata, such that the “capture zone” is calculated or determined, as at 55.

Thereafter, correlation occurs as at 58 through the operation of any one of a plurality of different type processors 20 capable of processing the integrated image data 54 stored on the storage medium 28 with appropriate mapping data 10 and the capture zone 55, as at 56. The correlation process accomplished by the processor 20 comprises selecting the appropriate mapping data as at 56 which may be in the form of conventional or customized mapping software and overlaying of the position/orientation indicator(s) and capture zone(s) in their proper location/orientation and size in relation to the mapping data. Accordingly, access to both the mapping data 56 and the integrated image data 54 by the processor 20 and by operative association therewith, a correlation is achieved as at 58 of the integrated image data 54, its capture zone 55, and the mapping data 56.

The mapping data 10 is in the form of one or more specific map applications 12, as at 60, wherein the integrated image data 62 is combined therewith by appropriate linking accomplished by the processor 20 utilizing the metadata. The result is the establishment of accessible display data 64 which, when clearly defined, may be viewed on any of a variety of different types of display assemblies 18. As represented in FIGS. 1A and 1B, the accessible display data is presented in the form of a map application 12, as at 66, which is populated with at least one, but more practically a plurality of symbols 30 thru 33 representing the position and orientation of the imaging assembly 22 when the image data of the respective or corresponding objects 13 thru 16 is captured. As also set forth above, the map application 12 will be representative of the actual position of various objects 13 thru 16. Further, the position/orientation of the symbols 30 thru 33 will be representative of the location of the imaging assembly 22 when the corresponding image data (photograph or video) is captured.

The compilation of the map application 12 and the one or more symbols 30 thru 33, the addition of appropriate bounding line of sight indicators 35, 36 (which partly define the capture zone), as well as the capture zone figures/shapes 100 are schematically represented as 68. Accordingly, once the integrated image data 54 and the mapping data 56 are correlated, as at 58, the established display data 64 is readily and selectively accessible as at 70 through manual positioning of a pointer, icon, etc, on the screen of the display assembly 18. The application of the pointer on any one of the position/orientation symbols 30 thru 33 or on the capture zone figures will result in the associated display of the image data in the form of the photograph of the specific object 13 through 16 which was captured. Further, the provision of the angle of view (as shown by the bounding lines 35, 36) will provide the viewer with appropriate boundaries of the field of view of the “capture zone” 100 of the imaging assembly 22 relative to a corresponding object 13 through 16, when disposed at any one of the position/orientations 30 thru 33. Therefore, the display of capture zones and of their associated image data 72 on the display assembly 18 is generally represented as in FIG. 1A and shown in greater detail in FIGS. 1B, and in three dimensions in FIGS. 2A2B 4A, 4B. After selective viewing of the displayed image data 72, the system and method of the present invention may end as at 74.

It is noted that the presentation of the objects 13 through 16, the corresponding site locations in the form of the map application 12, the symbolic location and orientation of the imaging assembly 22, as at 30 thru 33, and the capture zones, as at 100, 100″, 104, and 107, is representative only and serves as one example. By way of example only, other practical applications may comprise damage assessments by FEMA, insurance/accident scene reconstruction by insurance adjustors, real estate asset management and many other applications. Also, an entertainment or theme park may represent an appropriate application for the present invention, wherein photographs or videos of individuals or locations may be captured individually or in combination with one another. The image data comprising the photograph or video is stored on an appropriate storage medium 28 along with the metadata comprising the location and orientation of the imaging assembly 22 when the various photographs or videos (image data) were captured. As a result, storage of the data relating to the position, orientation, and angle of view of the imaging assembly 22, along with the original photographic or video image data on the storage medium 28 serves to define the integrated image data. As such, the storage medium 28 containing the integrated image data will be processed by an appropriate processor 20. As a further practical and possible application, a visitor in a theme park may present the storage medium 28 to a kiosk or other central facility which contains a library of mapping data 10, specifically in the form of one or more map applications 12 representative of various areas or sections of a theme park where the photographs or videos were taken. Operators of the kiosk or central facility will then further process the storage data 28 by correlating it with appropriate mapping data 10 in the form of one or more specific map applications 12 representative of the location site where the images were taken.

After processing, the user of the imaging assembly 22 will then be presented with a second appropriate memory facility such as a DVD or the like containing the established, accessible display data comprising the correlated mapping data 10 and the integrated image data. The DVD can then be repeatedly viewed on any appropriate display assembly 18 such as a DVD player wherein any of the symbols 30 thru 33 or capture zones defined in part by the bounding lines of sight indicators 35 and 36 can be readily accessed by a pointer, icon, etc. for display of the photograph and accurate determination of the position and orientation of the imaging assembly 22 and its capture zone when the photograph or video was captured.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for correlating captured images with site locations associated with the captured images, said system comprising:
an imaging assembly structured to capture image data and having position and orientation determining capabilities,
said image data including metadata relating to location and orientation of said imaging assembly,
a storage medium operative with said imaging assembly and structured to store said image data thereon,
mapping data representative of a site location of said imaging assembly during capture of said image data, and
a processor structured to establish accessible display data comprising correlated mapping data and image data.

2. A system as recited in claim 1 further comprising a display assembly structured to display and access said accessible display data.

3. A system as recited in claim 2 wherein said display assembly is operatively associated with said processor.

4. A system as recited in claim 1 wherein said position determining capability comprises a geographic positioning system operative to determine the position of said imaging assembly.

5. A system as recited in claim 4 wherein said geographical positioning system comprises a global positioning system.

6. A system as recited in claim 1 wherein said image data comprises at least one photograph.

7. A system as recited in claim 1 wherein said image data comprises at least one video display.

8. A system as recited in claim 1 wherein said correlated mapping data and image data comprise a map application populated with at least one symbol, said one symbol indicative of a capture zone associated with a location of said imaging assembly on said map application relative to a subject of the image data.

9. A system as recited in claim 8 wherein said one capture zone may be defined in three dimension by a field of view at least partially configured to comprise a regular pyramid with an apex adjacent a lens assembly of said imaging assembly, wherein an axis of symmetry is collinear with an optical axis of the lens assembly and perpendicular to the base of the pyramid.

10. A system as recited in claim 9 wherein said one capture zone is represented in two dimensions and defined by a plan view of the capture zone defined in three dimensions.

11. A system as defined in claim 8 wherein said at least one symbol further comprises at least one position/orientation indicator at least partially representative of an orientation angle of said imaging assembly relative to the subject of said image data.

12. A system as recited in claim 11 wherein said at least one position/orientation indicator comprises one or more radial lines extending outwardly from said at least one symbol.

13. A system as recited in claim 11 wherein said at least one position/orientation indicator further comprises at least one angle designator indicative of a central line of sight of said imaging assembly relative to a predetermined reference parameter.

14. A system as recited in claim 8 wherein said image data is linked to said at least one symbol and displayed by accessing said at least one symbol to display at least a photographed subject of the image data.

15. A system as recited in claim 1 wherein said correlated mapping data and image data comprise a map application populated with a plurality of capture zones each being indicative of at least one location of said imaging assembly on said map application.

16. A system as recited in claim 15 wherein each of said plurality of capture zones is indicative of a different location of said imaging assembly on said map application relative to a subject of said image data.

17. A system as recited in claim 15 wherein at least some of said plurality of capture zones further comprise at least one position/orientation indicator representative of a field of view of said imaging assembly relative to a corresponding subject of said image data.

18. A system as recited in claim 17 wherein at least some of said position/orientation indicators further comprise an angle designator indicative of a central line of sight of said imaging assembly relative to horizontal during capture of said image data.

19. A system as recited in claim 15 wherein said image data is linked to a plurality of symbols, each of said plurality of symbols indicative of al least one of said plurality of capture zones, said plurality of symbols being accessible to display a subject of the respective image data of a corresponding capture zone.

20. A method of correlating captured images with site locations of the captured images comprising:
positioning an image assembly to capture image data of a predetermined subject,
establishing metadata relating to position, orientation and angle of view of said imaging assembly and integrating the metadata into the image data,
accessing mapping data representative of a site location of the imaging assembly when capturing the image data, and
establishing accessible display data comprising a correlation of the mapping data and the integrated image data.

21. A method as recited in claim 20 comprising determining the location of the imaging assembly utilizing global positioning system capabilities.

22. A method as recited in claim 20 comprising defining the accessible display data to include a map application populated by at least one capture zone indicating at least the position of the imaging assembly during capture of the image data.

23. A method as recited in claim 22 comprising linking the integrated image data to the one capture zone for displaying the subject of the image data when the symbol is accessed.

24. A method as recited in claim 23 comprising associating at least one position/orientation indicator, representing a field of view of the imaging assembly relative to the subject of the image data, with the one capture zone.

25. A method as recited in claim 23 comprising associating at least one position/orientation indicator, representing a field of vision of the imaging assembly relative to the subject of the image data, with the one capture zone.

26. A method as recited in claim 25 including at least one angle designator with one position/orientation indicator and defining the angle designator as representing a central line of sight of the imaging assembly relative to a predetermined reference parameter.

27. A method as recited in claim 20 comprising populating the map application with a plurality of capture zones, each indicating a different position of the imaging assembly when capturing predetermined image data.

28. A method as recited in claim 27 comprising linking corresponding integrated image data with each of the plurality of capture zones for display of the corresponding image data when the respective capture zones are accessed.

29. A method as recited in claim 27 comprising associating at least one position/orientation indicator, at least partially indicating a field of view of the imaging assembly relative to the subject of the image data, with at least some of the plurality of capture zones.

30. A method as recited in claim 28 including at least one angle designator with at least some of the position/orientation indicators and defining each angle indicator as representing a line of sight of the imaging assembly relative to horizontal.
